(19) United States
(12) Patent Application Publication
(10) Pub. No.: US 2006/0029093 A1
(43) Pub. Date: Feb. 9, 2006

(54) Multimedia system over electronic network and method of use

(76) Inventor: Cedric Van Rossum, Hacienda Heights, CA (US)

Correspondence Address: Cedric Van Rossum;IPTV Systems, LLC, 2400 North Lincoln Ave., Altadena, CA, 91001, US

(21) Appl. No.: 11/199,865

(22) Filed: Aug. 8, 2005

Related U.S. Application Data
(60) Provisional application No. 60/600,135, filed on Aug. 9, 2004.
(60) Provisional application No. 60/604,156, filed on Aug. 23, 2004.

(51) Int. Cl. H04J 3/26

(52) U.S. Cl. 370/432

(57) ABSTRACT

A multimedia system over an electronic network, and the corresponding method of use for combining targeted advertising and on-demand rendering with a data swarming, multicasting, or time-shifted delivery. In a system that has business or technological constraints which prevent the encoding and/or the transmission of individually customized media content objects, in combination with an ad-hoc system, a delivery of one or more media content objects and a script list is performed in order to enable the rendering of one or more media content objects in accordance with information from the script list. Additionally, according to an embodiment, the system enables the insertion of watermarking information. In another embodiment, log file information are recorded and analyzed for decision making purposes. In another embodiment, lookup redirection techniques are disclosed when strict uniqueness of a transferred object is required.

### CROSS REFERENCE TO RELATED APPLICATION

The present application claims benefit of priority to U.S. provisional patent application Ser. No. 60/600,135 filed Aug. 9, 2004, entitled, “Advertising System Over Electronic Network and Method of Use” naming Cedric Van Rossum as inventor and incorporated herein by reference in its entirety.

The present application claims benefit of priority to U.S. provisional patent application Ser. No. 60/604,156 filed Aug. 23, 2004, entitled, “Advertising Selection System Over Electronic Networks and Method of Use” from the same inventor and incorporated herein by reference in its entirety.

### FEDERALLY SPONSORED RESEARCH

Not Applicable

### BACKGROUND OF THE INVETION

1. Field of the Invention

This invention relates to a multimedia system over an electronic network, specifically relating to systems which combine targeted advertising, watermarking and on-demand rendering with a data swarming or time-shifted delivery of media content.

2. General Overview and Need

The availability of the Internet enables new methods of directly distributing multimedia files to end-users in an electronic format. The advantages associated with electronic distribution are pushing providers of media content to establish global distribution systems for digital content.

At the same time, consumer demand for easily accessible and reasonably priced digital entertainment is growing.

Along with this opportunity, however, comes the risk of illegal distribution. In order to reduce this risk, media content must be protected throughout the distribution and consumption process. Digital Right Management is a technology that provides this kind of copyright protection.

The availability of new compression algorithms for multimedia data has dramatically reduced the bandwidth and storage space required for the electronic distribution of these data. It enables a more efficient distribution of the data, and at a higher definition.

The number of broadband users around the globe has reached a total of more than 100 million households, offering a new, universal distribution path for video-based entertainment. In the coming years, the availability of broadband will encourage a significant part of the media industry to adopt the Internet as a distribution channel in direct competition with established channels such as cable or satellite TV.

Movies on-demand systems over the Internet, such as Movielink and CinemaNow, deliver on-demand movies over the Internet. New companies are expected to enter the same market and some will choose to operate in a more “Personal” and “Time-shifted” manner similar to an Internet version of the PVR (Personal Video Recorder) business model.

The need to transfer media content to a portable media center device is progressively forcing the replacement of “Streaming” with “Download”, with the media content being downloaded first and then transferred to the portable player. This trend is reinforced by the existence of the highly addictive Tivo model which replaces “Real-Time” with “Personal TV Queue”. This model has been more successful than originally anticipated, and it will have a considerable impact on the way TV and video will be transferred over the Internet in the future. Unfortunately, there are not enough effective solutions for making this model applicable to the Internet because many vendors have been focusing too much R&D efforts on “real time streaming”.

According to Parks Associates, the total cumulative market for network-capable consumer electronics devices will reach 285 million units by 2008. It is a huge number of devices that can use and benefit from the system and method disclosed in the present invention. When combined with wireless networks and technologies such as wi-fi, these IP-enabled devices greatly facilitate the ability of the Internet to deliver TV and video content into the home.

Peer-to-peer file sharing systems for PCs are well known in the industry. Most of these systems have been accused of violating ownership rights of media content producers. At the same time, peer-to-peer is a very efficient technology that can be used to deliver media content in a legitimate manner to complement or replace traditional client-server download. An example of one such legitimate system is disclosed in PCT Application PCT/US04/13090 naming Cedric Van Rossum as inventor and incorporated herein by reference in its entirety. Said PCT patent describes a legitimate peer-to-peer system that can be used to deliver television over the Internet. Other different examples of legitimate peer-to-peer systems in the industry are certain Internet video-on-demand vendors who use peer-to-peer to deliver movies to their end-customers. Examples of such vendors can be found at the website Transmissionfilms.com using products from JIBE Inc., peer-to-peer download products from Red Shwoo or Kontiki, and BitTorrent. Each of these P2P systems has its own technological constraints. None of the systems mentioned above use or imply personal advertising.

According to the Yankee Group, 20% of U.S. households will own a Personal Video Recorder (or Digital Video Recorders) by 2007. Two-thirds of the owners of these recorders skip past the commercials presented on TV, representing a major threat for the TV industry because it dislocates the advertising- based model of television studios that rely on advertising revenue to produce creative content. Ad-skipping, by a majority of viewers, is forcing the industry to look for alternate technical solutions such as this invention.

The current ad insertion systems used by TV networks are extremely expensive and have several limitations in terms of the number of streams they can handle when multiplexing media content and commercials.

TV advertising is a multi-billion dollar market in the United States and many advertisers would be interested in making advertising more personal, with commercials customized for each viewer. The ads could be customized based on the user's profile, his history of watched media content, special events or promotions, demographics, geographic location, etc.

There are many limitations in current advertising systems. There is a need to create a better personal advertising system for the television industry, particularly for companies planning to adapt their business model for the Internet. There is also a need to create a better advertising system for the “personal” and “time-shifted” Internet television (or multimedia content in general) model. Finally, there is a need to create a customized advertising system that targets systems using a peer-to-peer or time-shifted method to deliver media content.

3. Discussion of Prior Art

Advertising Systems—Cable and Satellite TV

Advertising systems now used by traditional television networks are based on systems which insert ads in the television content. Examples include products from Terayon (CherryPicker for example), Adtec (Duet-SDI), or nCube (SkyVision) that enable cable operators to easily insert ads in their programming. Although variations exist, these systems usually have an architecture similar to the system illustrated in FIG. 1. These ad insertion systems include an Ad splicer (1A2) connected to a headend server (not illustrated) that multiplex the commercials or other interstitial content, stored in a storage device (1A4) with the original content (1A1) before transmitting the output streams (1A3) to the end-customers. A management and scheduling server (1A5) is generally also used to ensure that the proper ads are inserted at the correct time and are transmitted to the right audience and the right channel. The “SkyVision DPI and Analog Insertion” White Paper from nCube Inc., or the 2003 “Ad Insertion Applications” paper from Scopus, describe the characteristics of possible embodiments of these systems in greater detail. U.S. Pat. No. 6,857,132 is an example of just such a system which performs interstitial content insertion with the multiplexing of different content streams as used in current TV systems.

There are major disadvantages associated with these systems. They are extremely expensive because they require systems multiplexing data at high speed. They can only handle a limited number of channels. They are not able to deliver commercials customized for one identified viewer: they only customize ads for a determined, substantially large group of viewers. They are unable to deliver customized advertising to each viewer because the number of streams that has to be multiplexed—and individually transmitted—is too high for the current transmission pipes and signal mixers systems used by the operators.

Furthermore, these systems differ from the present invention since they generally do not store any ads on the receiving device of the user and/or they do not transmit any kind of ad insertion script list as detailed in the present invention. They only insert the ads on the network (upstream of the Television access point) and not on the receiving device (downstream of the access point). In addition, these systems are not compatible with electronic networks, such as the Internet, which makes these systems highly proprietary and difficult to inter-connect. Finally, these systems are closed-loop systems that are operated by a single cable operator and focus solely on real-time or near real-time insertion. This creates inter-connection and cross-compatibility problems between equipment from different vendors.

The present invention overcomes the above-detailed deficiencies of these systems.

Advertising Systems—Streaming

Ad insertion systems are known in the industry for inserting commercials in streaming content. These systems, which are based on dynamic ads insertion performed by a streaming server, are used, for example, to insert ads in Internet radio streams. An example of this type of technique includes the Ad Insertion system associated with the Helix Streaming server of RealNetworks Inc. which manages the way in which ads are inserted from the streaming server into the media streams. Similar systems from other streaming service vendors exist in the industry.

These ad insertion systems for streaming have a number of important limitations. Perhaps the most significant limitation is the requirement that a link be maintained to the streaming server that has to communicate (or trigger) information (or event) related to how and when the ads are to be inserted. The real-time nature of ad insertion with streaming is also incompatible with some business models, such as ads auction, since there is usually a too short period of time between the time a user selects a media content object for playback (play button) and the time an ad is inserted. The system disclosed in the present application solves this problem by emphasizing pre-delivery and by using a substantial delay to determine the optimal sequence of ads to be inserted. This delay may be used, for example to auction some ad slots or to execute some highly advanced ad insertion algorithms.

With streaming, the resolution of the media content and ads made available to viewers is also lower than with systems disclosed in the present patent application because of limitations related to the peak speed of the data transfers. To cite another disadvantage, a stack of ads that can be transmitted quickly must also be maintained close to the end-viewer's network access point in order to avoid glitches or buffering delays between the ads and the rest of the filmed content. Using special caching servers or a content delivery network buffer is often required which is expensive and often costs more than what the insertion of multimedia ads can be sold for.

With streaming, the information transmitted to the media player also uses an XML or SMIL format, which presents many security issues since XML and SMIL are available under a plain text format that can be edited and modified by end-users. The ads insertion algorithm with streaming is also always processed after the rendering decision (pushing on a “Play” button for example) has been made by a user.

To cite yet another problem, streaming is not well- suited for portable multimedia devices such as, for example, the iPod device from Apple or similar devices. There is currently no solution which would enable ad-supported streamed media content to be transferred to those devices. This is a significant problem in the industry because it is anticipated that ad-supported content will represent a significant portion of the market.

The present invention overcomes the above-detailed deficiencies of these streaming systems. Furthermore, this invention differs significantly in that it is intended for peer-to-peer delivery (unicast or multicast), time-shifted download models, or similar systems. The transmission of ad insertion information, media content and ads will occur before an object is made available for rendering.

Advertising Systems—Peer-to-Peer

Some peer-to-peer applications, such as Kazaa or similar applications, added advertising to their system in order to create additional sources of revenue. Its implementation is extremely primitive with only advertising banners displayed on a user interface. Another major problem with these systems is that they do not control the content made available on their network, which prevents them from using a script insertion system or customizing ads for a particular type of content. These systems do not use any advertising technology other than displaying web banners or other marketing messages on the screen of the end-user application before or during the download process. Furthermore, such systems transfer filmed content files directly (such as movie1.jpg) between users, with no transfer of script lists and no manipulation possible on the filmed content file (no event insertion, no split for a linear sequencing, etc.). The raw files (movie1.jpg) are also displayed directly on the user's screen, something which can be improved by the present invention.

Other advertising systems for peer-to-peer are known such as Gnutella-based networks that use “paid-search” advertising technologies, and return keywords ads in a similar manner as a search engine like Google, but for P2P searches. These P2P paid-search technologies are different than this invention in that (i) they display ads before an object is selected for download, (ii) they require a keyword search and (iii) advertising data are not stored on the user's playback system. The potential of these P2P paid-search technologies is also significantly limited because of the relatively low fee they can charge advertisers for only text link ads.

An example of a search-based media advertising system over peer-to-peer networks is illustrated in U.S. Provisional Patent Application 2005/0027821 (the ‘821’ system). The ‘821’ system suffers from the disadvantages mentioned above. Customization of the ads is extremely limited in the ‘821’ system because the ads are only targeted to the characteristics of the media content file selected.

The present invention corrects these problems and offers a technology which is significantly superior to these P2P advertising systems, since this unique invention enables the insertion of real, TV quality, fully customized ads during the rendering of media content distributed over a peer-to-peer delivery system.

Requirements

Video content transferred over an electronic network is exclusively available in digital format. The analog video signals have to be previously encoded for a particular type of player such as DivX from DivXNetworks Inc., Quicktime from Apple Corp., RealPlayer from RealNetworks or Windows Media Player from Microsoft.

The process of encoding these analog signals is a complicated one which can take several hours to complete for each media content object. There are severe technological constraints that prevent the insertion of commercials targeted for each (or a small number of) users before (or during) the process of encoding the analog signals: it is not technologically feasible, it takes too much time, it yields to too many different customized output files, and it is too expensive to do. Furthermore, technological constraints related to the data transport prevent the delivery of too many different copies. In particular, it can be demonstrated that too many different copies of the same content on a peer-to-peer or download network deteriorate the performance of the system because it limits the number of possible concurrent sources of data and/or the number of cached copies.

The solution proposed to this problem is to use the equivalent of script lists. These script lists provide instructions to the media players to insert ads (usually available as separate files) in one common media content object. These instructions indicates to the media player to:
a) hold rendering the main digital media content (for example a movie)
b) start rendering a secondary digital media content (for example a commercial) for a determined time (or until completion) before returning to the main digital media content.
   This process could be repeated to insert one or more commercials at different times in the movie and would function like a virtual switch performed by the media player application. When a user selects media content the user wants to play back, the associated script list would be transparently and automatically loaded. As an option, each media object present in a script list could be encoded with some fade-out or fade-in effect to make the rendering of a plurality of these media objects particularly smooth to the eye of a viewer.

In one possible embodiment, a script list accompanies every ad-supported media content object and it is generated for every user and/or every media content object selected. Other possibilities include a generic script list used for multiple users, a generic script list used for multiple media content objects, a script list that has not been received and is only generated by a client node or client node's system, a generic script list for any type of media content object, a script list generated for a particular type of media player; a script list generated for a combination of the above, etc.

The system and method disclosed in the present patent application are superior to current systems that focused mainly on XML metafiles, or the equivalent, for streaming. These systems have severe limitations since XML metafiles are viewable by many viewers and, in the case of peer-to-peer download or pre-delivery, they could be modified to illegitimately skip the commercials. It is therefore desirable to create a solution which prevents an end-user from tampering with or modifying the script list in order to illegally bypass the commercials inserted.

The invention also presents a script list technique that can be used to build a system with virtual insertion of watermarking information, which is very compelling to content producers. In another embodiment, a redirection technique is used when data delivery constraints require strict uniqueness of a common block of data delivered.

The system and method of this application enable the insertion of a large number of ads in a large number of media content objects at a low price while, at the same time, being compatible with the technological constraints discussed above.

### DRAWINGS

These and other features, aspects, and advantages of the present invention will become better understood with regard to the following descriptions, appended claims, and accompanying drawings where:

FIG. 1 shows one example of an ad insertion system for current television systems (such as one from Scopus Networks).

FIGS. 2A, 2B, 2C and 2D show possible embodiments of script lists.

FIG. 3 shows a flowchart of the main processes of one embodiment of the present invention.

FIG. 4 shows one embodiment of the system of the present invention.

FIG. 5 shows one embodiment of the conversion of a script list into a compiled or encrypted format.

FIG. 6 shows one embodiment of a log file.

FIG. 7 shows one embodiment of a script list including watermarking information.

FIG. 8 shows one embodiment of an interface presented to select one or more media content objects that have been received and are available for rendering.

FIG. 9 shows one embodiment of a description of the insertion of two ads in a media content object and how it is rendered to a user.

FIGS. 10A and 10B show possible embodiments of a script list delivery techniques.

FIG. 11 shows the details of a data transmission of the MAIN process of one embodiment of the present invention.

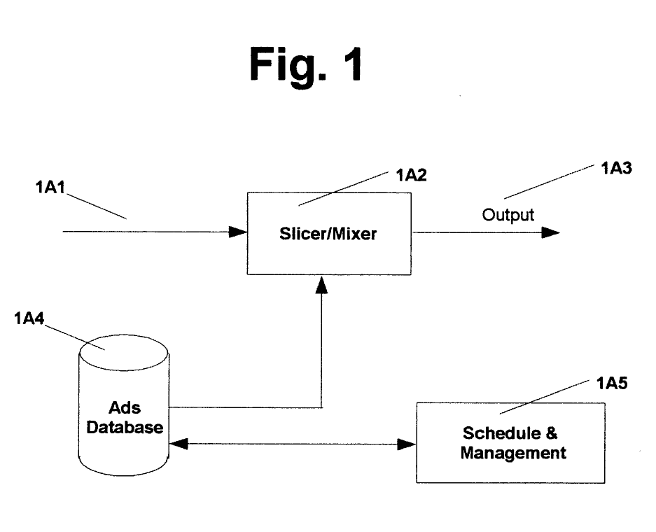

### DETAILED DESCRIPTION

### PRIMARY EMBODIMENT

Script List

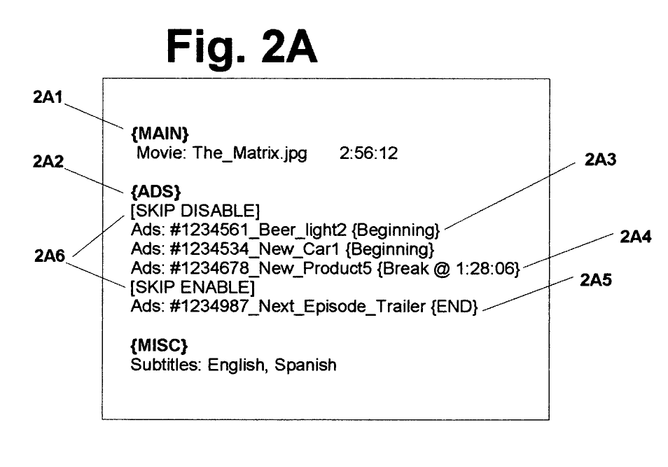

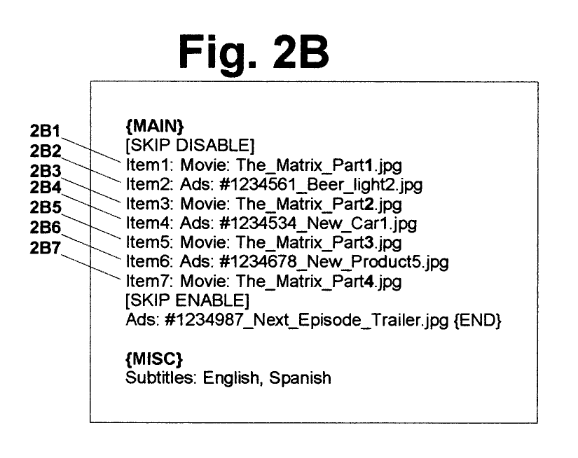

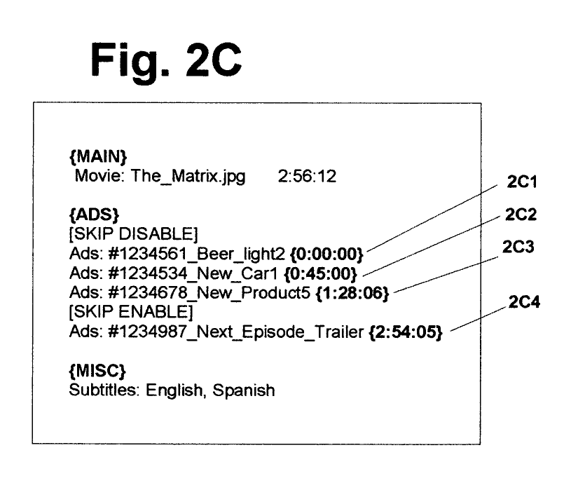

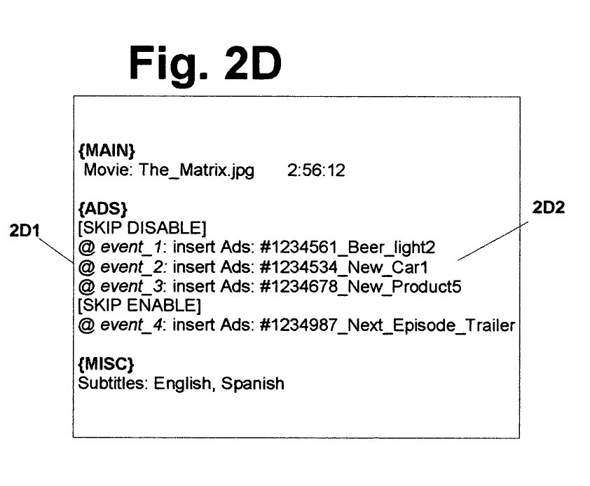

Possible embodiments of a script list are illustrated in FIGS. 2A, 2B, 2C and 2D. These script lists are small digital files that include information about the main media content (2A1), such as a movie, and multiple information about the ads that have to be inserted (2A2). These ads may be configured to be played at the beginning (2A3), during (2A4), or after (2A5) the main media content is played back. Miscellaneous configuration information can also be embedded in the script list to specify if the end-viewer can skip one or more of the ads or not (2A6). Additional optional data (not illustrated) can be inserted as well. These data can comprise one or more of the following items: metadata description, filename information (and in particular filename information related to the file that has to be passed first to a media player for initiating the playback), a unique or global identifier, a URL, timing information, programming code, conditional loop, event information, ordering information, watermark information, redirection information, text, images, or equivalent data. A very simple script list may include only one of the elements above and/or be embedded in another file such as a media content object, data in memory, code, or a torrent file.

The structure of script lists varies, but most of them can be categorized into, but not limited to, three different groups:
Linear sequencing (FIG. 2B), when the main media content is divided into a plurality of individual sections (2B1 to 2B7). Each section of the script is played in a determined order that includes the separate section of the main media content and one or more inserted ads.
Temporal sequencing (FIG. 2C), when the script includes information about when the ads have to be played (relative timing information, for example, such as items 2C1 to 2C4). Each ad is scheduled to be played at a particular moment during which the rendering of the main media content is interrupted. In this particular case, the main media content does not necessarily have to be split into different separate sections.
Event sequencing (FIG. 2D), when the script includes information indicating when and how ads (2D2) or other media content items should be played in response to different events (2D1) or triggering signals the rendering system can detect.

A simple computing device can generate a large number of script lists. The generated script lists are generated in a format compatible with a playback system. Different algorithms can be used to determine which and how the ads have to be inserted based on one or more criteria such as the title of the content, the type of content, the user who has selected the content, the probable viewer of the content, etc. An excellent example of such an algorithm is disclosed in U.S. Provisional Patent Application 60/604,156 titled “Advertising Selection System and Method of Use” from the same inventor and incorporated herein by reference in its entirety.

A script list can contain null data if no ads are found to be capable of being inserted in a particular media content object. Simplified version of script lists can also exist such as a simple arrangement of data or instructions that can be used to indicate a manner of rendering a media content object in conjunction with one or more distinct media content objects.

In another embodiment, the final script list can be at least partially generated locally by the receiving or rendering system of a user, generally after a method of generating the playlist has been specified (transfer of instructions, algorithm in the receiving system, etc.).

It is understood that the connections over electronic networks,as described herein and in the Figures, are representative and do not necessarily depict direct connections between the elements of the system. Intermediary routers or relay stations can be utilized to establish these connections.

It must be noted that the steps in the flowchart illustrations have been depicted in a serial manner to facilitate the comprehension of the processes. One skilled in the art will realize that with the availability of fast processors, “multi-thread” technologies, and other technological improvements in software and hardware will enable the steps of those processes to be performed in a parallel or near parallel manner. It is also understood multiple instances of these processes can co-exist and be run, independently or not, by one or more elements of the system. These instances may be related to one or more users participating to these processes. Furthermore, there may be a substantial time difference between the completion of one or more steps of these processes. Some steps may also be optional or performed in a different order under some conditions.

### DEFINITIONS

Unless defined otherwise, all technical and scientific terms used herein have the same meaning as commonly understood by one of ordinary skill in the art to which this invention belongs. Generally, the nomenclature used herein described below are well known and commonly employed in the art. Conventional methods are used for these procedures, such as those provided in the art and various general references. Terms of orientation such as “up” and “down” or “upper” or “lower” and the like refer to orientation of parts during use of a device. Where a term is provided in the singular, the inventor also contemplates the plural of that term. Where there are discrepancies in terms and definitions used in references that are incorporated by reference, the terms used in this application shall have the definitions given herein. As employed throughout the disclosure, the following terms, unless otherwise indicated, shall be understood to have the following meanings:
“Download” means the act or instance of transferring data or information over a network from a remote memory (source) to the local memory of another device (destination). This can be for a large file over a computer network, and can be utilized as a verb (referring to the action of downloading) or a noun (a download).
“Upload” means the act or instance of transferring data or information over a network from a local memory of a device (source) to a remote memory (destination). This can be a large file over a computer network, and can be utilized as a verb (referring to the action of uploading) or a noun (an upload).
“Downstream” means in the direction away from the source of a data stream.
“Upstream” means in the direction opposite of a data stream.
“Streaming” means playing sound or video in real time as it is downloaded in a steady flow over a network as opposed to storing it in a local file first. Streaming also refers to a flow of data, information or images or a technology that sends data from one point to another in a continuous mass of data.
“Multimedia” or “Media” means the combination of moving and still pictures, sound, music, and words, especially in entertainment, including, for example,movies, television programs, on-line classes, sporting events, songs, audio books, text or web pages, concerts, documentaries, home shopping programs, advertising, or the equivalent.
“Audio” means the transmission, reception, or reproduction of sound, also a sound signal.
“Audio” can further relate to sound or its reproduction, especially high-fidelity reproduction.
“Video” means the transmission, reception, or reproduction of moving images and sound, such as movies and television. “Video” also refers to the visual portion of television. “Video-on-demand (VoD or VOD)” means video signals delivered or transferred in real-time upon request.
“Digital rights management (DRM)” means a set of technologies media content owners can use to protect their copyrights. In most instances, a system that encrypts digital media content and limits access to only those users who have acquired a proper license to utilize the media content. DRM is a technology that enables the secure distribution, promotion, and sale of digital media content over the Internet.
“File-sharing” means sharing and distributing files to other users over an electronic network.
“Playback” or “Rendering” means the act or instance of reproducing previously recorded sound, video or pictures into a perceptible format.
“Watermark” means a hidden mark or other identifying information embedded in data or media content, most often as an invisible pattern of bits, allowing for the tracking of illegal use or unauthorized distribution of data which is usually copyrighted.
“Node” means an addressable device or an entity connected to a network or connected to a group. A data download reception unit, a user, a device, an operator, a portable multimedia device, or a server can be referred to as a node. Node may also refer to a module of a software system such as, for example, a media player application. “Peer” is an equivalent name for “Node”.
“Content” means something (one or more objects or scenes, for example) used by a creator for multimedia, audio or video representation. Content can refer to a movie, a TV show, or any other audio, media or filmed object and/or one of its features or its data. Content may also mean a part, an element, or a complex of parts.
“Sequencing” means a following of, or the action of following, one thing after another in time or in a serial arrangement in which things follow in logical order or a particular pattern. Sequencing may also mean to arrange objects in a sequence or to determine the order of constituents.
“Data swarming” means a peer-to-peer technology usually optimized for the transfer of a large volume of data to a large number of peers. BitTorrent, Swarmcast or Avalanche are data swarming technologies.
“Swarm” means a group of many constituents or the verb of moving in large numbers. In the particular case of electronic networks and/or peer-to-peer networks, a swarm may refer to a group of nodes participating in the data transfer of one identified, common object. A node can be part of different swarms when transferring multiple objects wherein each swarm has a different group of participating nodes. For example, a peer can be part of swarm #1 (transfer of movie #A), swarm #2 (transfer of advertisement #1) and swarm #3 (transfer of advertisement #2). All peers participating to swarm #2 have may have been determined to get advertisement #1 inserted during playback of movie #A.
“Server” means a computing program which provides some service to other client programs or computing devices. The connection between client and server is by means of message passing over a network, and utilizes a protocol to encode the client's requests and the server's responses. A server can also refer to a computing device which provides some service for other computing devices connected to it via a network. The term server can refer to both computing programs and computing devices. The functions of a server can be performed by either a single server or by multiple distributed servers. A single computing device server can perform multiple computing program server functions.
   Method and Mode of Operation
   Main Process

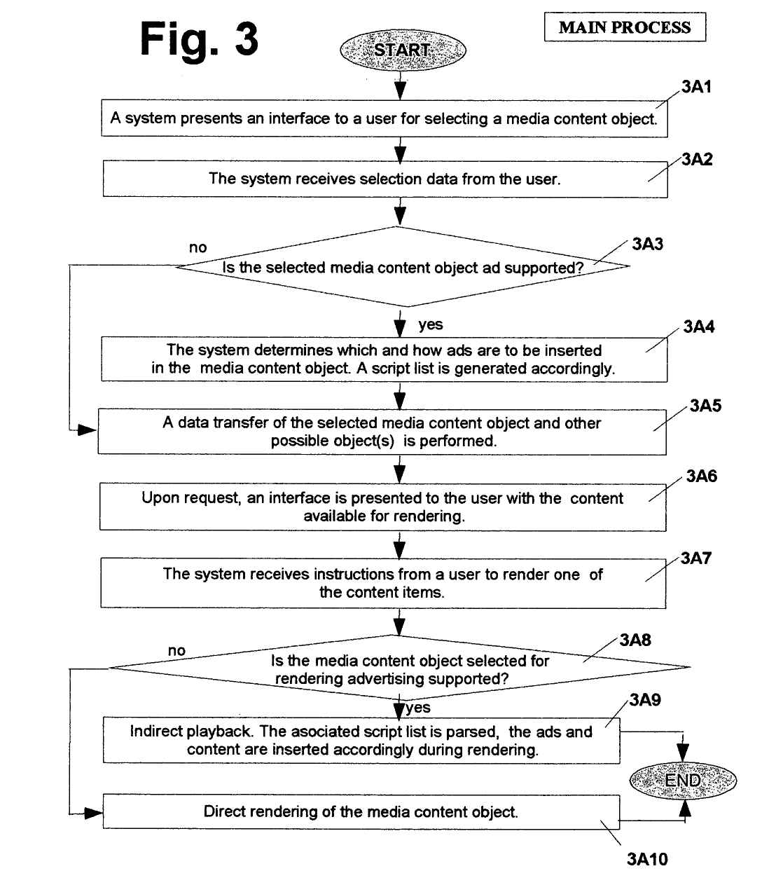

FIG. 3 illustrates an embodiment of the various component functions of the present invention.

The “MAIN” process describes the steps and operations performed by the elements of the system, as well as the interactions between said elements including one or more client nodes.

In the first step of this process, an interface is presented to a user to enable said user to select one or more media content objects said user desires to receive or render at a future time (step 3A1). A possible implementation of this interface would be, for example, an electronic programming menu on a TV, a RSS system, a website containing a library of movies available for rent, advertising banners or movie previews, a list of media content objects, or similar equivalent systems. It is assumed that the media content objects will be encoded in an appropriate format for digital distribution.

In the second step (step 3A2), once the media content object has been selected by the user, data representing this selection (such as electronic instructions) are received by a processing device (such as a server). This transfer of the selection data is for example performed over an electronic network, such as the Internet, with instructions passing over optional intermediary connected device(s).

Next, in step 3A3, the process determines if the selected content is supported by advertising. If the content is not advertising-supported, the process moves to step 3A5. If the content is advertising-supported, the process continues to step 3A4.

In step 3A4, the system determines which ads or other media content objects have to be inserted into said selected media content object during rendering. Different algorithms can be used in this step to determine which ads are to be used, and how the ads have to be inserted. In the same step, once the components that have to be inserted are known, a script list is generated accordingly by the system. The script list will be generated in a compatible manner with the playback system that is expected to be used for rendering the content. Information about the playback system may already be known by the system or be defined by the user when selecting the content. Step 3A4 may take a substantial amount of time to be executed because of different requirements, such as coordination with external systems, auctioning, communication with third-parties, or per the system's operator instructions. In the same step, optional transfer instructions may be computed by the system based on the generated script list. At the end of step 3A4, the process moves to step 3A5.

In step 3A5, the data forming the content selected is delivered over an electronic network to a receiving node. The transmission of other possible objects, such as ads, script lists or others, is usually performed in the same step but optionally with a distinct transfer method. More details about the data transfer mechanism are available below.

Once these elements (required for making a media content object available for selection for rendering) are received, the process proceeds to step 3A6.

In step 3A6, the process presents an interface to a user with the content previously selected which has been received and is available for rendering. The interface enables the user to select and send instructions regarding which media content object the user wants to playback. The objects required for initiating the rendering have been at least partially received before a media content object can be selected for rendering.

It must be noted that the process has been described so far for the selection of one media content object. However, the system supports the selection of multiple media content objects, such as different movies, for example. If more than one media content object is selected, steps 3A1 through 3A5 will be repeated for selecting each of the additional media content objects. The interface presented in step 3A6 will be updated accordingly, generally presenting a menu to a user with more than one media content object available for rendering (if applicable). The interface presents the objects in a coordinated manner. If the content is not ad-supported, the menu of step 3A6 may present the one or more content objects available for rendering by their respective title or filename. If the content is ad-supported and/or split into multiple smaller files (such as in the case of a linear sequencing script list), the menu of step 3A6 may present the one or more media content objects available for rendering in an aggregated format (such as the title of the movie) so that no information about the internal elements of the script list, the ads, the possible multiple filenames, or other details, is visible. There is a particular mechanism in the system that ensures that the display of ad-supported media content objects is performed properly, hiding some information from the user.

Next, in step 3A7, the system receives instructions from the user to render one of the media content objects available. The process then continues to step 3A8.

In step 3A8, the system determines if a media content object selected for rendering is advertising-supported or not (or has an associated script list or not). If the content is not advertising-supported, the process moves to step 3A10 and starts a direct playback session wherein the media player renders the media content object selected by the user. If the media content object selected for rendering is advertising- supported, the process moves from step 3A8 to step 3A9 and an “indirect” playback session is started in step 3A9 with the processing of a script list. The script file is first parsed by the media player and provides the appropriate information the player requires to render the media content with ads or other media content objects seamlessly inserted. Ads and media content data are therefore rendered accordingly, giving the user the impression of watching an undisrupted flow of content with inserted or juxtaposed commercials. The script will specify whether or not the user can skip the ads.

After step 3A9 or 3A10, the process exits the MAIN process. All the steps of this process can be repeated in a loop. If a user wants to watch a second media content object available for rendering, the process can be independently restarted from step 3A6.

Details of the Data Transfer Process

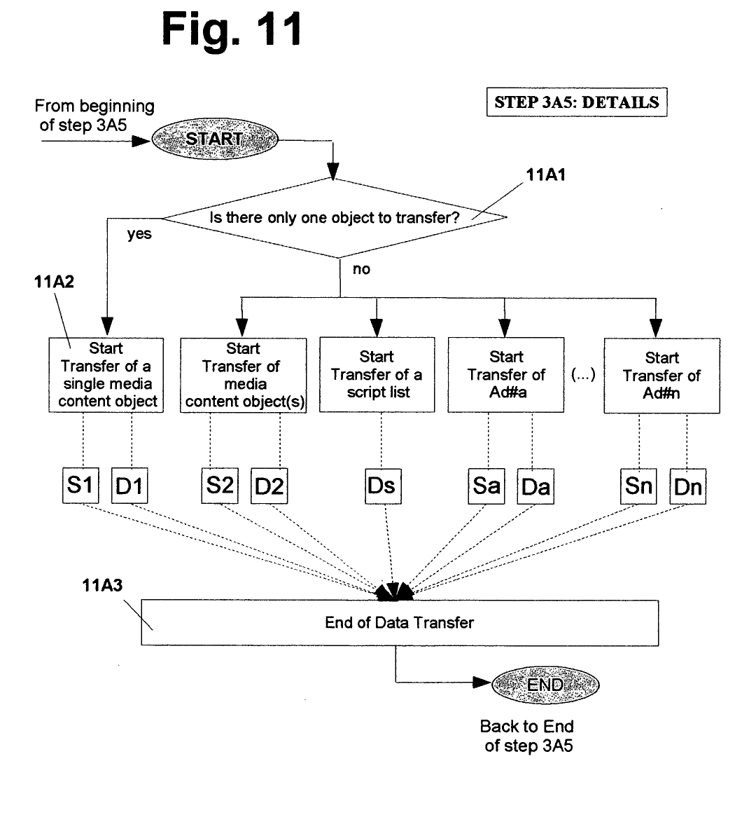

FIG. 11 illustrates more details about the transfer process of step 3A5.

In step 3A5, the data forming the media content are delivered over an electronic network to a receiving node. The system enables said data download transfer to be performed in a peer-to-peer manner (in conjunction with other nodes) or in a download or broadcast manner, usually time-shifted. With a peer-to-peer transfer, the node's receiving system is usually a participant of a bigger swarm. Multiple transfers can occur in an independent manner and/or at the same time, or not.

In one embodiment of the invention, a test is performed (step 11A1) to determine if optional objects (such as one or more ads, watermarks, special language or sound data, one or more script lists, one or more sub-sections of a bigger media content object . . . ) have to be delivered in addition to a main media content object. If only a single file has to be delivered (for example, if a media content object is not configured as ad-supported), the process jumps to step 11A2 to start the data delivery. A download D1 or a peer-to-peer transfer via swarm S1 is then started until the data transfer is completed and moves to step 11A3. If other objects have to be transferred, data delivery processes are started for each of the possible objects: media content object(s) can be transferred in a download D2 or swarm S2, script lists are transferred in a download Ds, a first ad is transferred in a download Da or a swarm Sa, other ads are transferred in a download Dn or swarm Sn, etc. When these transfers are completed, the process moves to step 11A3. The media object(s), the ads object(s) and the script list are delivered before that point in time when they are needed by the user or the user's system. This may include partial delivery of one or more data portions of these items (such as a progressive download of the main media content, for example).

After step 11A3, the process exits back to the MAIN process. It must be noted that transferring objects under a peer-to-peer method with said objects participating in distinct swarms (each with a different set of participating nodes such as for example a group of nodes determined to receive the same targeted ad), provides a significant advantage when compared with current media technologies because it can be demonstrated the system disclosed can deliver individually targeted ads while being more scalable and more cost-effective than streaming or downloading from a CDN (Content Delivery Network such as Akamai).

Hardware Description

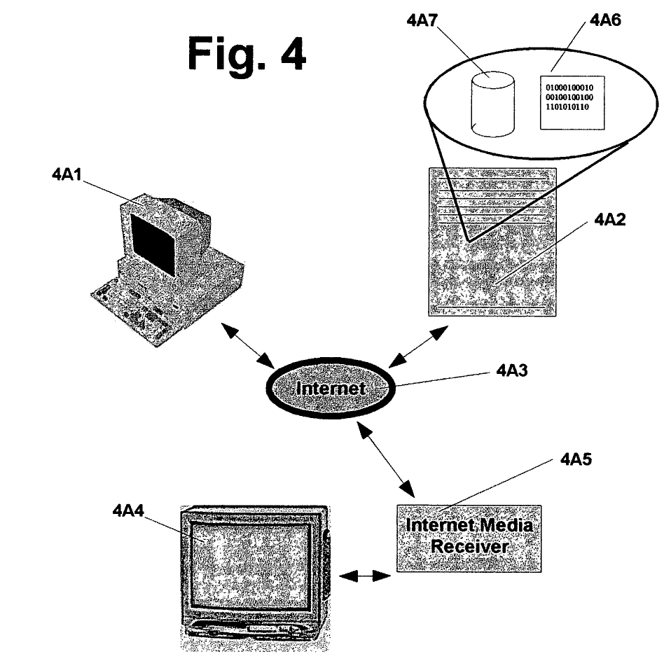

One embodiment of the invention disclosed in this application is described in FIG. 4. The system comprises a selection apparatus (4A1) that can display an interface with a menu of one or more media content objects a user of said system can select. There are several possible ways to implementing this apparatus such as, for example, a computer, a RSS system, a media center PC, a television with an electronic programming guide, a personal video recorder, a networked DVD player, a computer with access to a website, a portable media player, a PDA, or equivalent devices. There may be one or more apparatuses that can be used for one or more users.

The selection apparatus(es) are connected to an electronic network (4A3), such as the Internet, to transfer information about the content available for selection, information about the actual media content object(s) selected (electronic instructions), and/or to transfer information to other devices. A server (4A2) or equivalent processing device can receive and process the selection information received from one or more selection apparatuses (4A1). The server usually includes a repository of ads (4A7) and their associated information, as well as an ad's insertion mechanism (4A6) which is able to generate a script list specifying which ads should be inserted during the playback of a selected media content object, as well as the manner of such insertion. There may be multiple instances of these servers in the system, and the ad's repository or insertion algorithms may be connected in an indirect manner to the server. The server device is also capable of transmitting the script list information, the media content object(s), and ad(s) to a users receiving device (4A5) that will be used for rendering. The ad's repository may be implemented in one or more separate databases in another embodiment. Not illustrated is a repository of media content objects such as the database of a content delivery network or a distributed peer-to-peer network.

In one embodiment, the server 4A2 can include an ad selection system, as described in U.S. Provisional Patent Application 60/604,156 from the same inventor and incorporated herein by reference in its entirety.

The receiving device (item 4A5), which may be referred as an Internet Media Receiver, is capable of receiving and transmitting the data forming a media content object in a download transfer, broadcast/multicast transfer or a peer-to-peer transfer. When operating in a peer-to-peer mode, each receiving device is a potential source (“seed server”) or sink (“leech server”) of data for one or more other receiving devices. The device is further capable of receiving script list information and advertising content objects or similar objects, as well as rendering the objects in accordance with information from said received script list. Software is usually present on this device so that said device can also operate as the media player. The receiving device (4A5) is capable of rendering the content in a direct playback session (wherein the media player renders the content selected by the user) or in an indirect playback session. When the receiving device parses the script file and passes the information the player needs to render the content with ads seamlessly inserted.

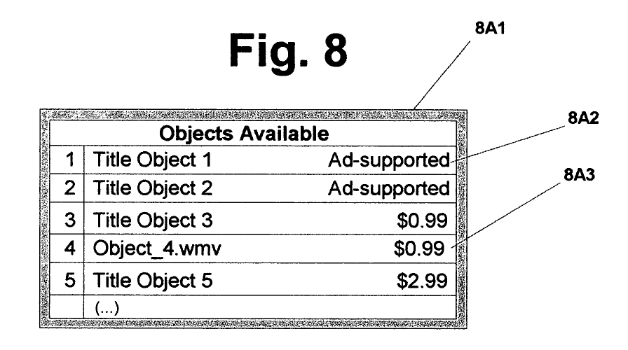

As illustrated in FIG. 8, the receiving device is directly or indirectly capable of presenting an interface (8A1) with a menu, displaying for the user one or more media content objects available for rendering. The receiving device is also able to display the content available for rendering in a coordinated manner, whether or not the media content objects displayed are ad-supported. Information about media content objects that are not ad-supported (8A3) can be presented directly (filename.jpg for example). If the media content objects are ad-supported (8A2) (or split in multiple smaller files such as in the case of a linear sequencing script list), the receiving device can present the one or more media content objects available for rendering in an aggregated format (such as the title of the movie) so that NO information about the internal structure of the script file, the ads, or possible multiple filenames, are displayed. There is a special mechanism in the receiving system that sees to it that the display of ad-supported media content objects is performed properly, hiding some information from the user.

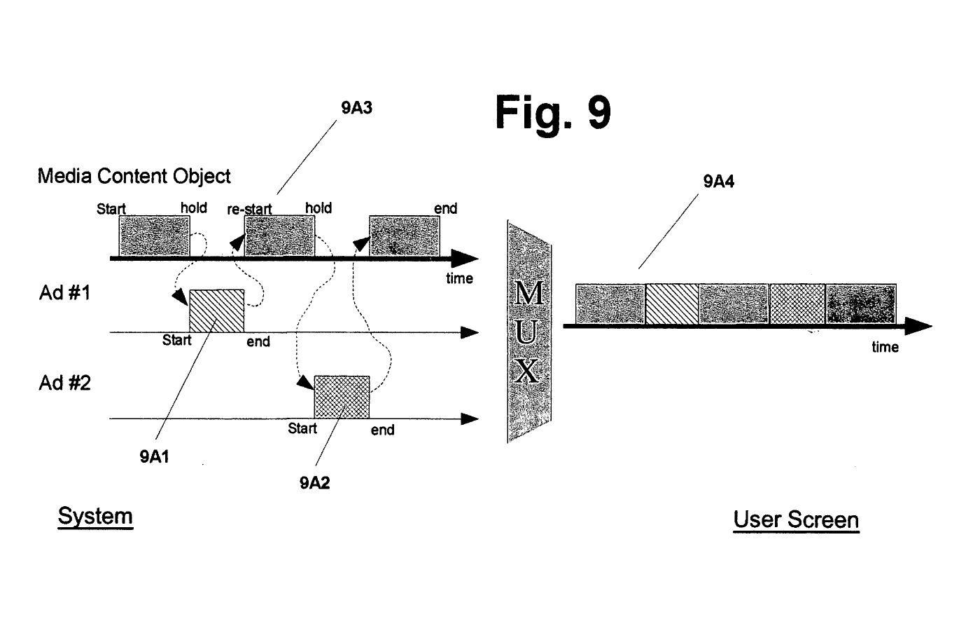

As illustrated in FIG. 9, the receiving device can render the ads (9A1 and 9A2) and the media content (9A3), giving the user the seamless impression of watching an uninterrupted flow of content (9A4) with inserted commercials. In one embodiment, the rendering of the media content (9A3) is put on hold when the ads (9A1 and 9A2) are inserted. In another embodiment, ads and the main media content can be rendered simultaneously (images superposition). The receiving device (4A5) comprises a mechanism that is also able to prevent ads from being skipped if necessary.

A restitution or rendering device (4A4) is connected to an output connection of the receiving device (4A5) so that decoded data can be displayed on the restitution device. Examples of such restitution devices would be a TV, a computer screen, a stereo system, a LCD screen, etc.

The restitution device (4A4) and receiving device (4A5) may be combined to form a single device such as a media Center PC. These items may also be combined with the selection apparatus. Additional servers such as a main repository of media content objects or a plurality of seed servers from a Content Delivery Network may be available as well for facilitating the distribution of the content.

### OPTIONAL EMBODIMENTS

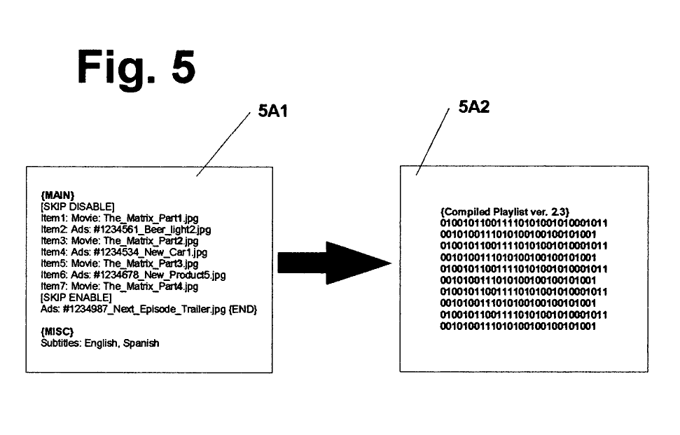

The receiving device (item 4A5 in FIG. 4) may comprise a computer or a portable multimedia player. It is desirable to ensure the viewer should not be able to manipulate the script list received. This is an important feature because some users may try to eliminate the inserted commercials by tampering with the script list. An effective solution is illustrated in FIG. 5. For this reason, the script list (SAl) transmitted to the receiving device may be converted into an encrypted, compiled, or non-editable format (5A2) for a user. A digital signature or hashcode can also be integrated to provide the same kind of protection. This feature is a significant improvement over XML metafiles which are plain text files that can be easily modified by a user. The method described above corrects this problem by making the elements of the system capable of handling compiled or non-editable script lists.

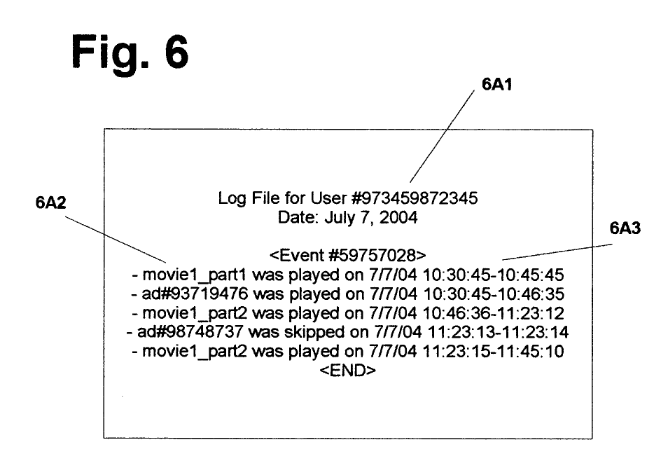

Another proposed solution to this problem is to combine the playback of the content and the inserted ads with a log file. The log file is a file reporting the details about the playback of the files and associated timing data. It is generally protected against tampering or digitally signed. An exemplary embodiment of such a log file is illustrated in FIG. 6. The log file (6A1) is a data file associated with a user's system and comprises information about the rendering of the media content objects (including ads) (6A2) and optional associated timing information (6A3). The log file is for example obtained from the media player or a DRM system. The log file information is then sent back to a server that will analyze and verify the log file data are compliant with the expected rendering sequence and the timing defined in the script list. It can for example determine if one or more media content objects have been rendered or not, even if a partial rendering or skipping occurred. If there are major discrepancies, the user will be for example prevented from selecting additional advertising-supported media content objects. If the user has been tampering with the script list in one way or another, the user may incur a penalty or other actions may be taken. Other scenarios are also possible, such as incentivizing the user or affecting the future rendering of media content objects. The elements of the system described in the present application (such as, for example, server 4A2) are capable of handling, creating and analyzing the log file from one or more users and then taking appropriate action based on the analysis of said log files.

It is also desirable to be able to use the system described in this application with portable multimedia devices. Therefore, in one embodiment, a portable media player can comprise a mechanism to integrate the selection apparatus, the receiving device and the rendering system, as described above. In an alternate embodiment, the receiving device 4A5 will comprise an electronic interface to transfer the media content objects, the ads, and associated script lists (in an encrypted format, for example) to a portable multimedia player able to perform the functions of the process described above. This process, a novel and unique creation in the industry, is part of the method described in the present patent application.

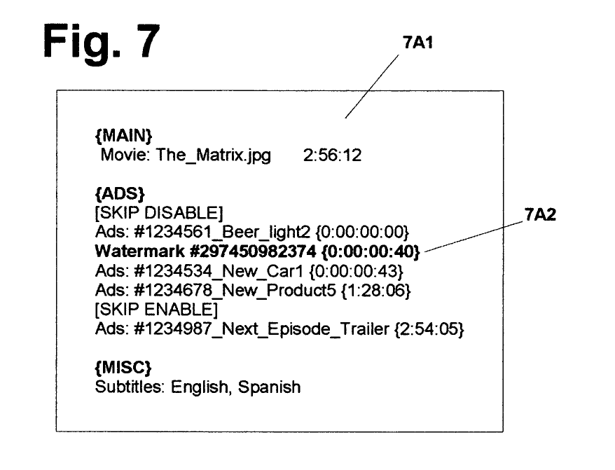

In another embodiment, the script list technique described in this application is used to insert one or more shorter media content objects (usually a few video frames) that include watermarking information. The script list is configured (item 7A1 in FIG. 7) to insert one or more very short video sequences that contain watermarking information during rendering. These watermarking frames are only displayed for a short period of time (7A2) which prevents a user from seeing them. Such watermarking information is used by content producers to track illegitimate copies of the content that may be recorded by capturing video on the output signals of the receiving device. The present system is capable of generating the video sequences with watermarking information and inserting said sequences within the content in a manner similar to that used for inserting commercials. Inserting watermarking information is usually performed with an encrypted script list as described above.

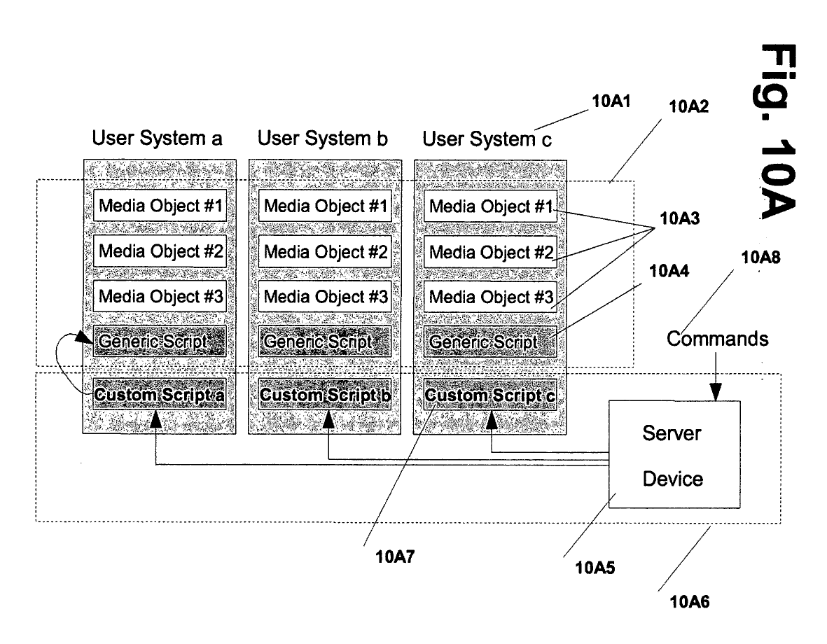

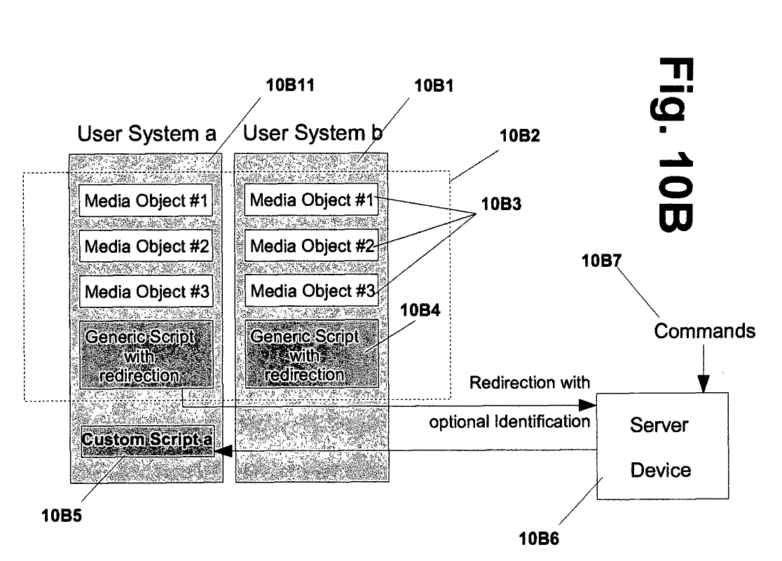

In yet another embodiment, the present invention includes a redirection (also known as lookup) technique when strict uniqueness of the transferred objects is required. Some delivery technologies, such as certain peer-to-peer transfers, require that the script list, usually transferred as part of a larger group of data transferred over one or more swarms, for example, is not being customized before its delivery to multiple client nodes such as, for example, to maintain hash code consistency. Different methods illustrated in FIGS. 10A and 10B exist to overcome this problem.

First Method (FIG. 10A):

A default generic script list (10A4), usually common to a high number of client nodes, is transferred over a peer-to-peer mesh (10A2). The script list is identical for each node and is part of a larger group of data transferred over a first swarm.

A separate script (10A7), customized for one or more client node's systems (lOAl), is transmitted separately from a server device (10A5), which may be identical to server 4A2, and replaces or supplements the generic script list (10A4). The customized script list (lOA7) is normally at least partially received before the associated media player initiates the rendering. It is the content of the customized script (10A7) that is passed to the media player for rendering.

The system disclosed in this patent application includes a mechanism, embedded in server 4A2 in one embodiment, to automate the transmission of a script list similar to item 10A7 at or near the end of a data transfer of other media content objects per commands (10A8) received from an operator. The delivery of this customized script list is repeated for multiple client nodes and may replace the generic script list.

The mesh 10A2 may be comprised of a plurality of different swarms, each with different participating nodes transferring one or more objects in common.

Second Method (FIG. 10B);

A generic script list (10B4), usually common to more than one client node (10B1 and 10B11), is transmitted as part of a delivery of different media objects (10B3) over a peer-to-peer mesh (10B2). The generic script list (10B4) includes some redirection information such as, for example, a URL, to a separate server device (10B6) configured upon instructions (10B7) received from an operator. Said redirection information forces the media player to receive a script (10B5) customized for one or more particular nodes, (such as 10B11 in FIG. 10B). It is the content of the customized script (10B5) that is used to determine how one or more media content objects (10B3) should be rendered. The redirection is performed when the rendering is initiated.

It must be noted that the present invention does not require that all the advantageous features and all the advantages be incorporated into every embodiment of the invention. It must be ftrther noted that the present invention can be implemented across multiple varieties of networks. One skilled in the art will realize that the present invention, while described herein as applicable to cable systems and the Internet, can additionally be applicable to any type of network infrastructure, existing or future, including but not limited to satellite, radio transmissions, and wireless technologies. The present invention can be readily implemented across existing networks, in conjunction with current technologies on those networks. The invention further relates to a computer program for enabling a programmable device when executing said computer program to perform as the system or the steps of the method, with some or all its features, disclosed herein.

### CONCLUSION

An innovative and much improved system and method for inserting ads in TV, video or media content in general has been disclosed. This system and method may be particularly suitable for time-shifted, personal Internet television systems. In the particular case of peer-to-peer networks, it would enable these networks to be ad-supported and therefore, would increase the proliferation of LEGITIMATE ad-supported versions of peer-to-peer networks.

Although the present invention has been described in considerable detail with reference to certain versions thereof, other versions are possible. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference. All the features disclosed in this specimen, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method of providing multimedia content over an electronic network comprising:
a) transferring one or more media content objects to one or more nodes of said electronic network;
b) making a script list available to one or more nodes of said electronic network, wherein said script list is related to one or more of said media content objects; and
c) rendering one or more of said media content objects into a perceptible format in accordance with information from said script list.

2. The method of claim 1, wherein any step of claim 1 further comprises consideration of any or a combination of:
a) an electronic data transfer over said electronic network;
b) a peer-to-peer or data swarming transfer to a first group of one or more of said nodes of said electronic network;
c) a peer-to-peer or data swarming transfer to a second group of one or more of said nodes of said electronic network, wherein said second group is distinct from said first group;
d) a data transfer between two devices;
e) a multicasting or broadcasting data transfer.

3. The method of claim 1, wherein step a) has associated business or technological constraints that prevent a substantially different media content object from being transferred to each or to a group of a low number of said nodes.

4. The method of claim 1, wherein one or more of said media content objects is comprised of one or any combination of the following elements:
a) an entire multimedia object;
b) a sub-section of a multimedia object;
c) a descriptive object;
d) an advertising object; or
e) an object with watermarking information;
wherein one or more of said elements may be available under a media file format.

5. The method of claim 1, wherein step c) is firther determined to be performed in a skippable or non skippable manner.

6. The method of claim 1, wherein said script list comprises one or more of the following elements: metadata description, filename information, a unique or global identifier, a URL, timing information, information determining an entity that must be passed first to a media player, programming code, conditional loop, event information, ordering information, priority information, watermark information, redirection information, text, images, or equivalent data.

7. The method of claim 1, wherein:
a) said script list is available in a technology that prevents an unauthorized view or unauthorized modification of said script list; and
b) said technology may include a compilation process, an encryption process, a digital signature, a protected access, or an equivalent process.

8. The method of claim 1, wherein said script list is customized for an individual or for a substantially low number of:
a) identified nodes;
b) identified media content objects;
c) rendering modules; or
d) any combination of the above.

9. The method of claim 1, further comprising the step of performing an electronic redirection to enable a customization of said script list from a separate device; wherein said electronic redirection includes optional identification of one or more of said nodes.

10. The method of claim 1, wherein step c) is further comprised of the steps of:
d) switching back and forth a rendering of one or more of said media content objects with a rendering of one or more others of said media content objects in accordance with information from said script list; and
e) optionally optimizing said switching in order to obtain a seamless transition during rendering;
wherein two or more of said media content objects may be rendered simultaneously.

11. The method of claim 1, further comprising the preliminary step of encoding one or more of said media content objects into a digital format, wherein:
a) business or technological constraints may prevent at least one section of one or more of said media content objects from being encoded in a customized manner for an individual or a substantially low number of said nodes; and
b) fade-in or fade-out effects may be added when encoding one or more of said media content objects.

12. The method of claim 1, further comprising one or a combination of the steps of:
g) presenting a first interface for selecting one or more of said media content objects for transfer, wherein the step of presenting said first interface may be performed before any of the steps of claim 1;
h) presenting a selection interface for selecting one or more of said media content objects for rendering, wherein the step of presenting said selection interface may be performed before step c) of claim 1;
i) receiving a first set of instructions to transfer one or more of said media content objects, wherein the step of receiving said first set of instructions may be performed before any steps of claim 1;
j) receiving playback instructions to render one or more of said media content objects into a perceptible format, wherein the step of receiving said playback instructions may be performed after step a) and b) of claim 1;
k) performing a conditional test to determine if one or more of said media content objects has an associated script list or not, wherein said conditional test may comprise a detection of advertising content.

13. The method of claim 12, wherein step h) further comprises one or more of the optional steps of:
a) presenting or hiding one or more determined elements of said script list on said selection interface;
b) hiding from said selection interface one or more of said media content objects associated with one or more others of said media content objects presented on said selection interface;
c) coordinating the presentation of a plurality of said media content objects on said selection interface.

14. The method of claim 12, further comprising the step of determining a particular object required to initiate a rendering of one particular of said media content objects selected for rendering upon said playback instructions.

15. The method of claim 1, further comprising the step of acquiring log information for one or more of said nodes of said electronic network; wherein
a) said log information includes information about the rendering of one or more of said media content objects;
b) said log information may be available in a technology that prevents an unauthorized view or an unauthorized modification of said log information, wherein said technology may include compilation, encryption, digital signature, protected access, or a similar technology; and
c) said log information may be obtained from a DRM system.

16. The method of claim 15, further comprising one or more of the steps of:
a) performing an analysis of said log information to determine a way one or more of said media content objects has been rendered; and
b) optionally using the results of said analysis to take action on:
i. one or more of said nodes; or
ii. future rendering of one or more of said media content objects.

17. The method of claim 1, further comprising the steps of:
d) determining which of said media content objects should be rendered in conjunction with the rendering of one or more other of said media content objects; and
e) generating one or more of said script lists and optional transfer instructions accordingly;
wherein step d) and e) may be performed before step c) of claim 1.

18. The method of claim 1, wherein step b) is performed at a substantially distinct moment as compared with step a), with said distinct moment preceding the point in time that said script list is required for initiating rendering.

19. The method of claim 1, wherein step b) is further comprised of one or more of the preliminary steps of:
b) transferring a generic version of said script list to one or more of said nodes of said electronic network; and
c) replacing said generic version of said script list with a customized script list.

20. The method of claim 1, further comprising the step of transferring one or more of said media content objects and one or more of said script lists associated with one or more of said media content objects to a portable media player.

21. A method for providing advertising to a peer-to-peer network comprising the steps of:
a) combining a first peer-to-peer data transfer of a media content object to one or more nodes of said peer-to-peer network with a data delivery of one or more advertising objects to one or more of said nodes, wherein:
i. one or more of said advertising objects are determined to be rendered in conjunction with a rendering of said media content object; and
ii. said data delivery may comprise a second peer-to-peer data transfer that may be distinct from said first peer-to-peer data transfer; and
b) making a script list available to one or more of said nodes of said peer-to-peer network, wherein:
i. said script list is related to one or more of said advertising objects and said media content object;
ii. said script list may be customized for an individual or a low number of nodes of said peer-to-peer network; and
iii. said script list may be available in a technology that prevents an unauthorized view or an unauthorized modification of said script list; and
c) rendering said media content object in conjunction with the rendering of one or more of said advertising objects in accordance with information from said script list.

22. The method of claim 21, further comprising one or more of the steps of:
d) including a generic script list in the data of said first peer-to-peer data transfer of said media content object to one or more of said nodes of said peer-to-peer network; and
e) replacing said generic script list with a customized script list.

23. The method of claim 21, wherein any step of claim 20 is performed in an automated process.

24. The method of claim 21, further comprising the steps of:
a) determining which of said advertising objects should be rendered in conjunction with the rendering of said media content object; and
b) generating a script list and optional transfer instructions accordingly, wherein said script list may be customized.

25. A method for improving the rendering of one or more media content objects over an electronic network comprising the steps of:
a) acquiring log information for one or more particular nodes of said electronic network, wherein said log information includes information about the rendering of one or more of said media content objects;
b) performing an analysis of said log information to determine the way one or more of said media content objects have been rendered; and
c) using results of said analysis to take action on any one of, or a combination of:
i. one or more of said nodes; or
ii. future rendering of one or more of said media content objects.

26. The method of claim 25, wherein:
a) said log information may be available in a technology that prevents an unauthorized view or an unauthorized modification of said log information, wherein said technology may include compilation, encryption, digital signature, protected access, or a similar technology; and
b) said log information may be obtained from a DRM system.

27. The method of claim 25, wherein step b) further comprises the step of comparing said log information with other information that may include a description of a way of rendering one or more of said media content objects.

28. A system for providing multimedia content over an electronic network comprising:
a) one or more receiving devices connected to said electronic network, wherein said receiving devices comprise:
i. means for transferring one or more media content objects and one or more script lists over said electronic network;
ii. means for storing one or more of said media content objects and one or more of said script lists; and
iii. a rendering engine capable of rendering one or more of said media content objects into a perceptible format in accordance with information from one or more of said script lists;
b) one or more of said script lists, wherein one or more of said script lists comprise data related to one or more of said media content objects;
c) one or more of said media content objects, wherein one or more of said media content object may comprise one or more of the following elements:
i. an entire multimedia object;
ii. a sub-section of a multimedia object;
iii. a descriptive object;
iv. an advertising object;
v. an object with watermarking information;
wherein one or more of said elements may be available under a media file format;
d) one or more processing devices connected to said electronic network comprising an electronic mechanism capable of making one or more of said script lists available to said rendering engine; and
e) one or more seed servers connected to said electronic network comprising a storage and transfer mechanism capable of transferring one or more of said media content objects from one or more of said seed servers to one or more of said receiving devices, wherein:
i. one or more of said seed servers are optional; or
ii. one or more of said seed servers are integrated into one or more of said receiving devices.

29. The system of claim 28, further comprising one or more of said receiving devices comprising means for being a potential source or sink of one or more of said media content objects to one or more others of said receiving devices.

30. The system of claim 28, further comprising one or more nodes of said electronic network capable of exchanging data through multicasting or broadcasting.

31. The system of claim 28, further comprising one or more nodes of said electronic network capable of exchanging data through a peer-to-peer protocol, wherein:
a) said peer-to-peer protocol may include a BitTorrent or equivalent protocol; and
b) one or more of said nodes of said electronic network may be capable of participating in a plurality of distinct swarms.

32. The system of claim 28, wherein said electronic network is available under a technology that prevents a substantially different media content object from being transferred to each or to a group of a low number of said receiving devices.

33. The system of claim 28, wherein said data of one or more of said script lists indicate if one or more of said media content objects can be rendered in a skippable or non skippable manner.

34. The system of claim 28, wherein one or more of said script lists comprises one or more of the following data fields: metadata description, filename information, a unique or global identifier, a URL, timing information, information determining an entity that must be passed first to a media player, programming code, conditional loop, event information, ordering information, priority information, watermark information, redirection information, text, images, or equivalent data fields.

35. The system of claim 28, wherein:
a) one or more of said script lists is available under a technology that prevents an unauthorized view or unauthorized modification of one or more of said script lists; and
b) said technology may include a compilation mechanism, an encryption mechanism, a mechanism for digitally signing one or more of said script lists, a mechanism for restricting access, or a similar mechanism.

36. The system of claim 28, wherein one or more of said script lists comprise data customized for an individual or a substantially low number of:
a) identified receiving devices;
b) identified media content objects;
c) identified rendering engines; or
d) any combination of the above.

37. The system of claim 28, further comprising:
i. means for performing an electronic redirection to a separate device, wherein said separate device comprises an algorithm for customizing one or more of said script lists; and
ii. optional means for combining said electronic redirection with an identification of one or more of said receiving devices.

38. The system of claim 28, wherein said rendering engine further comprises:
a) an electronic switch for switching back and forth the rendering of one or more of said media content objects with the rendering of one or more others of said media content objects in accordance with information from said script list; and
b) optional means for obtaining a seamless transition during the rendering of step a);
wherein said rendering engine may comprise a mechanism for rendering two or more of said media content objects simultaneously.

39. The system of claim 28, further comprising an encoding server connected to said electronic network, wherein said encoding server comprises an algorithm for encoding one or more of said media content objects into a digital format, wherein:
a) said algorithm or storage means of said encoding server prevent one or more sections of one or more of said media content objects from being encoded in a customized manner for an individual or for a substantially low number of receiving units; and
b) said algorithm for encoding one or more of said media content objects may comprise fade-in or fade-out algorithms.

40. The system of claim 28, wherein one or more nodes of said electronic network further comprise an algorithm comprising a conditional test for determining if one or more of said media content objects has an associated script list or not, wherein said algorithm may comprise a software routine for detecting advertising content.

41. The system of claim 28, further comprising one or more of the following optional elements:
f) a selection apparatus connected to said electronic network, wherein:
i. said selection apparatus may comprise an electronic interface for selecting one or more of said media content objects for transfer over said electronic network; and
ii. said selection apparatus may comprise a mechanism for receiving instructions to transfer one or more of said media content objects;
g) a display interface connected to said receiving device, wherein:
i. said display interface may comprise a selection interface for selecting one or more of said media content objects for rendering; and
ii. said display interface may comprise a mechanism capable of receiving playback instructions to render one or more of said media content objects into a perceptible format.

42. The system of claim 41 wherein said display interface further comprises an algorithm capable of:
a) hiding data of one or more of said script lists from said display interface;
b) hiding one or more of said media content objects associated with one or more others of said media content objects presented on said selection interface;
c) coordinating the presentation of one or more of said media content objects on said selection interface.

43. The system of claim 28, further comprising a device connected to said electronic network capable of acquiring log data for one or more nodes of said electronic network; wherein:
a) said log data include data about the rendering of one or more of said media content objects;
b) said log data may be available in a technology that prevents an unauthorized view or an unauthorized modification of said log data, wherein said technology may include a compilation mechanism, an encryption mechanism, a mechanism for digitally signing said log data, a mechanism for protecting access to said log data, or a similar mechanism; and
c) said device may comprise a DRM server.

44. The system of claim 43, further comprising a processing device capable of:
a) performing an analysis of said log data to determine how the rendering of one or more of said media content objects has been performed; and
b) upon results of said analysis, taking action on any one of, or on a combination of:
i. one or more of said nodes;
ii. the future rendering of one or more of said media content objects.

45. The system of claim 28, further comprising a server capable of:
a) determining which of said media content objects should be rendered in conjunction with the rendering of one or more others of said media content objects; and
b) generating one or more of said script lists and optional transfer instructions accordingly.

46. The system of claim 28, further comprising a mechanism for making one or more of said script lists available to said rendering engine a substantial time after one or more of said media content objects have been transferred to one or more of said receiving devices.

47. A system for providing advertising to a peer-to-peer network comprising:
a) a peer-to-peer network comprising a plurality of media content objects stored on a plurality of peers of said said peer-to-peer network;
b) a plurality of peers connected to said peer-to-peer network comprising a combination of:
i. means for transferring and storing one or more advertising objects;
ii. means for transferring and storing one or more of said media content objects;
iii. a rendering engine capable of rendering one or more of said media content objects in conjunction with the rendering of one or more of said advertising objects and in accordance with information from a script list;
iv. means for receiving said script list and making said script list available to said rendering engine; and
c) a server connected to said peer-to-peer network comprising:
i. means for determining one or more of said advertising objects to be rendered in conjunction with a rendering of one or more of said media content objects and generating said script list accordingly;
ii. means for customizing said script list;
wherein:
iii. said script list is related to one or more of said advertising objects and one or more of said media content objects; and
iv. one or more of said peers may comprise a mechanism for transferring a plurality of said media content objects over a plurality of distinct swarms.

48. The system of claim 47, further comprising a mechanism for transferring a generic version of said script list to one or more of said peers of said peer-to-peer network and replacing said generic version of said script list with a customized script list.

49. A system for improving the rendering of one or more media content objects comprising:
a) a plurality of playback devices, wherein:
i. said playback devices are capable of rendering one or more of said media content objects into a perceptible format in accordance with a predetermined manner and with optional instructions received from a user; and
ii. said playback devices are capable of storing log information describing the manner in which one or more of said media content objects has been rendered;
b) a computing device comprising a mechanism for:
i. acquiring said log information for one or more particular playback devices; and
ii. performing an analysis of said log information to determine how the rendering of one or more of said media content objects has been performed; and
c) a server comprising a processing mechanism for taking actions upon results of said analysis, wherein said actions may include actions on any one of, or on a combination of:
i. the future rendering of one or more of said media content objects;
ii. one or more of said playback devices;
iii. one or more users.

50. The system of claim 49, further comprising:
b) log information that may be available in a technology that prevents an unauthorized view or an unauthorized modification of said log information, wherein said technology may include a compilation mechanism, an encryption mechanism, a digital signature mechanism, a protected access mechanism, or a similar mechanism; and
c) an optional DRM server capable of providing at least part of said log information.

51. The system of claim 49, wherein said computing device further comprises a mechanism for comparing said log information with other information.

52. A system for rendering one or more media content objects transferred over a peer-to-peer network, comprising an arrangement of digital data wherein:
a) said digital data can be used to indicate a manner of rendering into a perceptible format at least one of said media content objects in conjunction with one or more distinct media content objects, wherein one or more of said media content objects are transferred over said peer-to-peer network; and
b) said arrangement of digital data is available in a format compatible with a media player.

53. The system of claim 52, wherein:
a) said digital data are customized for (i) a single node or a plurality of nodes of said peer-to-peer network, for (ii) one or more of said media content objects, or for (iii) a combination of one or more nodes and one or more media content objects;
b) said arrangement of digital data is formatted for accompanying a transfer of one or more of said media content objects over said peer-to-peer network.

54. The system of claim 52, wherein one or more of said digital data comprise one or more of the following data fields: metadata description, filename information, a unique or global identifier, a URL, timing information, information determining an entity that must be passed first to a media player, programming code, conditional loop, event information, ordering information, priority information, watermark information, redirection information, text, images, or equivalent data fields.

55. In a peer-to-peer network capable of transferring one or more media content objects, the improvement wherein said peer-to-peer network comprises:
a) means for transferring and storing one or more of said media content objects;
b) means for automatically transferring and storing one or more advertising objects after at least one section of one or more of said media content object has been transferred;
c) a rendering engine capable of rendering one or more of said media content objects in conjunction with the rendering of one or more of said advertising objects and in accordance with information from a script list;
d) one or more script lists;
e) means for automatically receiving one or more of said script lists and making said script list available to said rendering engine before a playback of one or said media content object is initiated; and
f) means for determining one or more of said advertising objects to be rendered in conjunction with a rendering of one or more of said media content objects and generating said script list accordingly.
